(19) United States
(12) Patent Application Publication
(10) Pub. No.: US 2015/0338976 A1
(43) Pub. Date: Nov. 26, 2015

(54) TOUCH DISPLAY DEVICE

(71) Applicants: BOE Technology Group Co., Ltd., Beijing (CN); Hefei BOE Optoelectronics Technology Co., Ltd., Anhui (CN)

(72) Inventors: Tong Yang, Beijing (CN); Ming Hu, Beijing (CN); Byung Cheon Lim, Beijing (CN); Yubo Xu, Beijing (CN)

(21) Appl. No.: 14/418,564

(22) PCT Filed: Apr. 29, 2014
(86) PCT No.: PCT/CN2014/076459

§ 371 Date: Jan. 30, 2015

(30) Foreign Application Priority Data
Dec. 9, 2013 (CN) 201310666643.5

(51) Int. Cl. G06F 3/041

(52) U.S. Cl. CPC G06F 3/0412

(57) ABSTRACT

Disclosed is a touch display device to improve uniformity of signal when a signal is transmitted through a touch drive electrode and/or a touch sensitive electrode. The touch display device comprises: a touch drive electrode extending in a first extension direction and including a first end and a second end opposite to the first end in the first extension direction; a touch sensitive electrode extending in an second extension direction and including a first end and a second end opposite to the first end in the second extension direction; a signal transmission source electrically connected to the touch drive electrode for providing the touch drive electrode with a voltage signal; and a detection circuit electrically connected to the touch sensitive electrode for determining a touch position on a touch panel of the touch display device, wherein the signal transmission source is electrically connected to the touch drive electrode at a first connecting point located between the first end and the second end of the touch drive electrode; and/or the detection circuit is electrically connected to the touch sensitive electrode at a second connecting point located between the first end and the second end of the touch sensitive electrode.

### CROSS-REFERENCE TO RELATED APPLICATION

This Application is a Section 371 National Stage Application of International Application No. PCT/CN2014/076459, filed 29 Apr. 2014, which has not yet published, which claims priority to Chinese Patent Application No. 201310666643.5, filed 9 Dec. 2013, in Chinese, the contents of which are hereby incorporated by reference in their entirety.

### BACKGROUND OF THE INVENTION

1. Field of the Invention

Embodiments of the present invention generally relate to field of touch display technique, in particularly to a touch display device.

2. Description of the Related Art

A Touch Panel (TP) comprises an Out Cell Touch Panel independent of a display panel and a Touch Panel integrated with the display panel. The Touch Panel integrated with the display panel mainly includes On Cell Touch Panel in which a touch module is disposed on a side of a color filter substrate of the display panel away from an array substrate and an In Cell Touch Panel in which the touch module is disposed on a side of the color filter substrate close to the array substrate and/or on a side of the array substrate close to the color filter substrate.

The touch module mainly comprises a touch drive electrode and a touch sensitive electrode. Generally, during the use of the touch panel, a high-frequency voltage signal V0 is applied to the touch drive electrode and a constant voltage signal V1 is applied to the touch sensitive electrode, and a detection circuit connected with the touch sensitive electrode will detect an initial current value I0. When the touch panel is touched, an actual voltage value at a touch point may vary due to this touch, and the detection circuit will detect an actual current value I1. A position of the touch point can be determined by determining a change of the actual current value I1 relative to the initial current value I0. Thus, the voltage values V0 at all positions on the touch drive electrode are required to be equal to one another, i.e., signal intensity on the touch drive electrode is uniform. In this way, the initial current values I0 at different untouched positions on the touch drive electrode are equal to one another and when a touch occurs, the positioning of the touch point is more accurate.

In practice, the signal intensity on the touch drive electrode will be gradually attenuated as a signal transmission distance is increased. In addition, the signal intensity on the touch sensitive electrode will be gradually attenuated as the signal transmission distance is increased. In the prior art, a signal input interface on the touch drive electrode is located at either or both ends of the touch drive electrode, which causes a large signal attenuation at a position on the touch drive electrode away from the input interface such that the signal can not even be detected by the detection circuit connected with the touch sensitive electrode. Similarly, a signal output interface on the touch sensitive electrode is located at either or both ends of the touch sensitive electrode. Thus, a signal from a position on the touch sensitive electrode away from the output interface has a great attenuation when arriving at the output interface such that the detection circuit can not accurately locate the touch point.

### SUMMARY OF THE INVENTION

Embodiments of the present invention provide a touch display device to improve uniformity of signal when a signal is transmitted through a touch drive electrode and/or a touch sensitive electrode and to improve the accuracy for positioning a touch point.

The touch display device comprises: a touch drive electrode extending in a first extension direction and including a first end and a second end opposite to the first end in the first extension direction; a touch sensitive electrode extending in a second extension direction and including a first end and a second end opposite to the first end in the second extension direction; a signal transmission source electrically connected to the touch drive electrode for providing the touch drive electrode with a voltage signal; and a detection circuit electrically connected to the touch sensitive electrode for determining a touch position on a touch panel of the touch display device, wherein the signal transmission source is electrically connected to the touch drive electrode at a first connecting point located between the first end and the second end of the touch drive electrode; and/or the detection circuit is electrically connected to the touch sensitive electrode at a second connecting point located between the first end and the second end of the touch sensitive electrode.

According to an exemplary embodiment of the present invention, the touch drive electrode comprises a plurality of first sub-electrodes connected with one another by first connecting lines. The touch sensitive electrode comprises a plurality of second sub-electrodes connected with one another by second connecting lines. The signal transmission source is connected with at least one first sub-electrode located between the first end and the second end of the touch drive electrode or at least one connecting line between the first sub-electrodes by a first lead to transmit a signal through the entire touch drive electrode via the first lead; and/or the detection circuit is connected with at least one second sub-electrode located between the first end and the second end of the touch sensitive electrode or at least one second connecting line between the second sub-electrodes by a second lead to receive signals output from the second lead.

According to an exemplary embodiment of the present invention, the signal transmission source is also connected with at least one of the first end and the second end of the touch drive electrode; and/or the detection circuit is also connected with at least one of the first end the second end of the touch sensitive electrode.

According to an exemplary embodiment of the present invention, separations between the first connecting points on the touch drive electrode connected with each of the first lead are equal to each other; and/or separations between the second connecting points on the touch sensitive electrode connected with each of the second lead are equal to each other.

According to an exemplary embodiment of the present invention, the touch display device further comprises an array substrate on which the touch drive electrode and the touch sensitive electrode are disposed. The lead for connecting the signal transmission source with the touch drive electrode is located in a non-display region between pixels on the array substrate; and/or the lead for connecting the detection circuit with the touch sensitive electrode is located in the non-display region between pixels on the array substrate.

According to an exemplary embodiment of the present invention, the touch drive electrode and the touch sensitive electrode are time-divisionally driven so that the touch drive electrode and the touch sensitive electrode serve as a common electrode performing a function of driving liquid crystals during an image display stage, and the touch drive electrode and the touch sensitive electrode perform touch drive function and a touch sensing function respectively during a touch stage.

According to an exemplary embodiment of the present invention, the first connecting line for connecting the first sub-electrodes is a conductive sheet located between the first sub-electrodes; and/or the second connecting line for connecting the second sub-electrodes is a conductive sheet located between the second sub-electrodes.

According to an exemplary embodiment of the present invention, the first connecting line for connecting the first sub-electrodes is one conductive wire or a plurality of conductive wires parallel with one another for simultaneously connecting each first sub-electrode of the touch drive electrode, the conductive wire(s) directly contacting with each first sub-electrode without an insulating layer therebetween; and/or the second connecting line for connecting the second sub-electrodes is one conductive wire or a plurality of conductive wires parallel with one another for simultaneously connecting each second sub-electrode of the touch sensitive electrode, the conductive wire(s) directly contacting with each second sub-electrode without an insulating layer therebetween.

According to an exemplary embodiment of the present invention, the first sub-electrode is of a rhombic or regular polygonal shape; and/or the second sub-electrode is of a rhombic or regular polygonal shape.

According to an exemplary embodiment of the present invention, each of the first lead and the second lead is made of metal or alloy.

According to an exemplary embodiment of the present invention, each of the first connecting line and the second connecting line is made of metal or alloy.

In view of the above, in the touch display device according to embodiments of the present invention, the signal transmission source is electrically connected to the touch drive electrode at the connecting point between the first end and the second end of the touch drive electrode for transmitting a signal through the entire touch drive electrode; and/or the detection circuit is electrically connected to the touch sensitive electrode at the connecting point between the first end and the second end of the touch sensitive electrode for receiving a signal output from the touch sensitive electrode. Provided that a maximum value of a voltage signal input to each touch drive electrode is set as Vₘₐₓ, and a minimum value of the voltage signal through the entire touch drive electrode after being attenuated is set as Vₘᵢₙ, it proves that the touch display device according to the present invention has a high signal uniformity and a better touch effect as compared with a touch display device in which a signal is input from an end of the touch drive electrode.

### BRIEF DESCRIPTION OF THE DRAWINGS

The above and other features of the present invention will become more apparent by describing in detail exemplary embodiments thereof with reference to the accompanying drawings, in which:

FIG. 1 is a schematic structural view of a touch drive electrode according to an exemplary embodiment of the present invention;

FIG. 2 is a schematic structural view of a touch sensitive electrode according to an exemplary embodiment of the present invention;

FIG. 3 is a diagram respectively showing a change in voltage in different regions on the touch drive electrode when a signal is input from an end of the touch drive electrode in FIG. 1 and when a signal is input from a connecting line between the ends of the touch drive electrode in FIG. 1;

FIG. 4 is another schematic structural view of a touch drive electrode according to an exemplary embodiment of the present invention;

FIG. 5 is another schematic structural view of a touch sensitive electrode according to an exemplary embodiment of the present invention;

FIG. 6 is a schematic top view of a touch drive electrode and a touch sensitive electrode on an array substrate according to an exemplary embodiment of the present invention;

FIG. 7 is an equivalent simulated diagram of a touch drive electrode according to an exemplary embodiment of the present invention; and

FIG. 8 is a schematic diagram showing a comparison in uniformity of signal between a touch drive electrode of the present invention and that of the prior art.

### DETAILED DESCRIPTION OF PREFERRED EMBODIMENTS OF THE INVENTION

Embodiments of the invention provide a touch display device to improve uniformity of signal when a signal is transmitted though a touch drive electrode and/or a touch sensitive electrode and to improve the accuracy for positioning a touch point.

The concept of the present invention will now be described with reference to various embodiments. It should be noted that the embodiments are intended to illustrate concept of the present invention by way of example only, rather than limiting the present invention.

According to an exemplary embodiment of the present invention, each of the touch drive electrode and the touch sensitive electrode extends in a certain direction and includes a first end and a second end opposite to the first end in the direction, and in each of the touch drive electrode and the touch sensitive electrode, a plurality of sub-electrodes are connected in serial with one another by connecting lines. The touch drive electrode and the touch sensitive electrode may extend in a same or different directions. It is assumed that the touch drive electrode consists of a plurality of first sub-electrodes connected in serial by connecting lines. It is assumed that the touch sensitive electrode consists of a plurality of second sub-electrodes connected in serial by connecting lines.

In a touch display device according to an embodiment of the present invention, the signal transmission source may be connected with a connecting line between the first sub-electrodes of the touch drive electrode by a lead to transmit a signal through the entire touch drive electrode via the lead connected to the touch drive electrode; and/or the detection circuit is connected with a connecting line between the second sub-electrodes by a lead to receive a signal output from the lead connected to the touch sensitive electrode. Voltages in different regions on the entire touch drive electrode and/or the entire touch sensitive electrode are uniform. In this way, it is possible to improve the accuracy for positioning a touch point.

In a touch display device according to another embodiment of the present invention, the signal transmission source may be connected with at least one intermediate first sub-electrode between the first end and the second end of the entire touch drive electrode by a lead to transmit a signal through the entire touch drive electrode via the lead connected to the touch drive electrode; and/or the detection circuit may be connected with at least one intermediate second sub-electrode between the first end and the second end of the entire touch sensitive electrode by a lead to receive a signal output from the lead connected to the touch sensitive electrode. Voltages in different regions on the entire touch drive electrode and/or the touch sensitive electrode are uniform. In this way, it is possible to improve the accuracy for positioning a touch point.

According to a further embodiment of the present invention, each touch drive electrode and each touch sensitive electrode may be an integrated electrode having a first end and a second end opposite to the first end in an extending direction thereof. The signal transmission source may be electrically connected to the integrated touch drive electrode at a connecting point between the first and second end thereof; and/or the detection circuit may be electrically connected to the integrated touch sensitive electrode at a connecting point between the first and second end thereof. In this way, it is also possible to improve the uniformity of the voltage in different regions on the entire touch drive electrode and/or the touch sensitive electrode, thereby improving the accuracy for positioning a touch point.

The touch display device according to embodiments of the present invention may comprise a touch panel independent of a display panel (Out Cell Touch Panel) or a touch panel disposed outside a display panel (On Cell Touch Panel) or a touch panel disposed inside of a display panel (In Cell Touch Panel).

Embodiments according to the present invention will be described with reference to drawings in which film thickness and shape of each layer will not reflect the true scale of the touch panel and the display device, and it is intended to only illustrate the concept of the present invention.

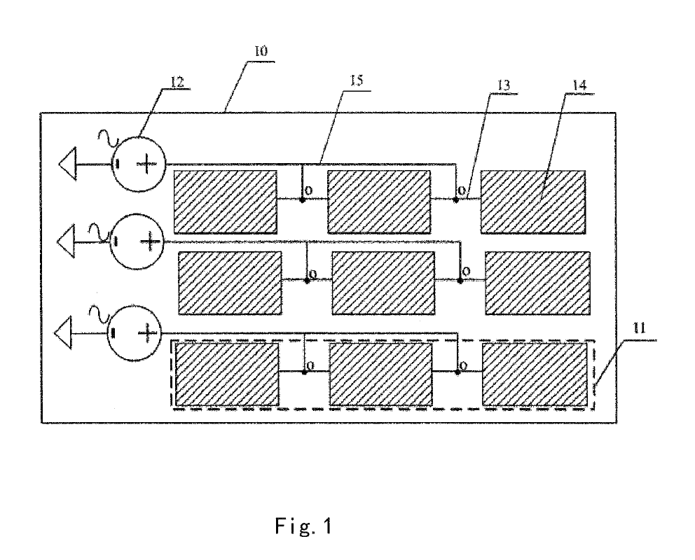

FIG. 1 is a schematic top view of a touch display device according to an exemplary embodiment of the present invention in which only a touch drive electrode 11 and a signal transmission source 12 on a substrate 10 are shown in order to more clearly illustrate the structure of the touch drive electrode in the touch display device.

Referring to FIG. 1, the touch display device comprises the touch drive electrode 11 on the substrate 10 extending in a length direction of the substrate 10 and a signal transmission source 12 providing the touch drive electrode 11 with a signal. The touch drive electrode 11 includes a plurality of first sub-electrodes 14 connected with one another by a connecting line 13. The signal transmission source 12 is connected with the connecting line 13 between the first sub-electrodes 14 by a lead 15 at a connection point 0 shown in FIG. 1 for transmitting a signal through the entire touch drive electrode 11 via the lead 15. FIG. 1 shows three touch drive electrodes 11 and each touch drive electrode 11 includes three first sub-electrodes 14. The number of the touch drive electrodes, however, is not limited herein, and the number of the sub-electrodes included in each touch drive electrode is not limited herein either.

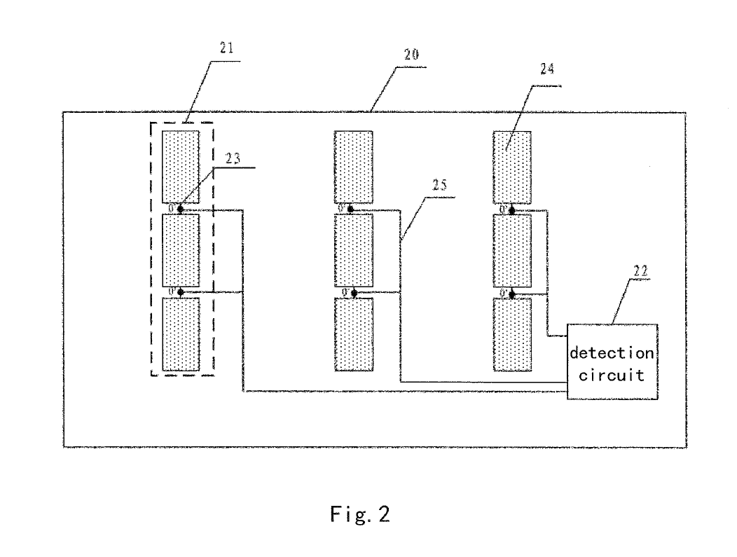

FIG. 2 is a schematic top view of a touch display device according to an exemplary embodiment of the present invention in which only a touch sensitive electrode 21 and a signal detection circuit 22 on a substrate 20 are shown in order to more clearly illustrate the structure of the touch sensitive electrode in the touch display device. Referring to FIG. 2, the touch display device comprises the touch sensitive electrode 21 on the substrate 20 extending in a width direction of the substrate 20 and a detection circuit 22 connected with the touch sensitive electrode 21 for positioning a touch point. The touch sensitive electrode 21 includes a plurality of second sub-electrode 24 connected with one another by a connection line 23. The detection circuit 22 is connected to the connection line 23 between the second sub-electrodes 24 by a lead 25 at a connection point O′ shown in FIG. 2 for receiving a signal output from the lead 25. FIG. 2 shows three touch sensitive electrodes 21 and each touch sensitive electrode 21 includes three second sub-electrodes 24. The number of the touch sensitive electrodes, however, is not limited herein, and the number of the sub-electrodes included in each touch sensitive electrode is not limited herein either.

In the touch display devices as shown in FIGS. 1 and 2, the signal transmission source 12 is connected with the connecting line 13 between the plurality of first sub-electrodes 14 by the lead 15, and the detection circuit 22 is connected with the connecting line 23 between the plurality of second sub-electrodes 24 by the lead 25.

In an alternative embodiment of the present invention, the signal transmission source 12 may be connected with an intermediate first sub-electrode of the plurality of first sub-electrodes other than the first sub-electrodes located at both ends by a lead. The detection circuit 22 may be connected with an intermediate second sub-electrode of the plurality of second sub-electrodes other than the second sub-electrodes located at both ends by a lead.

For example, the present invention defines the uniformity of signal of the entire touch drive electrode or the touch sensitive electrode as a ratio (Vₘᵢₙ/Vₘₐₓ) of the minimum value Vₘᵢₙ to the maximum value Vₘₐₓ in the voltage values in difference regions on the entire touch drive electrode or the touch sensitive electrode.

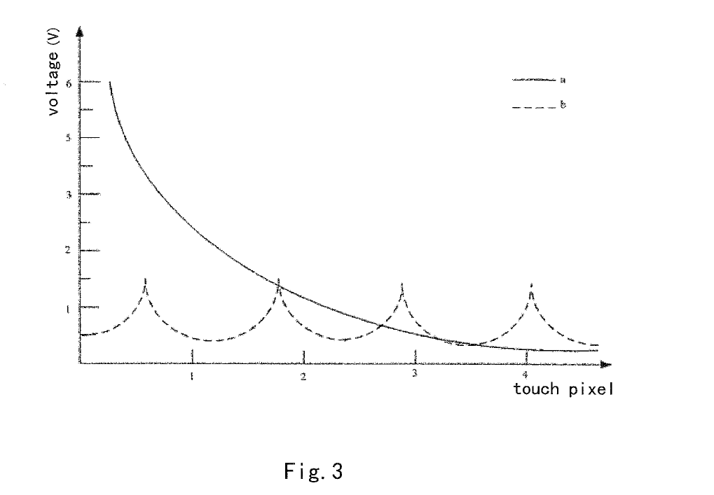

Taking the touch drive electrode as an example, FIG. 3 is a diagraph showing respectively a change in voltage in different regions on the touch drive electrode when a signal input from an end of the touch drive electrode as shown in FIG. 1 is transmitted in the touch drive electrode(corresponding to the curve a) and a change in voltage in different regions on the touch drive electrode when a signal input from the connecting line between the first sub-electrodes of the touch drive electrode as shown in FIG. 1 is transmitted in the touch drive electrode (corresponding to the curve b).

As is apparent from FIG. 3, the uniformity of the voltage signal input from the end of the touch drive electrode is smaller than that of the voltage signal input from the connecting line between the first sub-electrodes of the touch drive electrode while ensuring touch effect of each touch region. The minimum voltage value Vₘᵢₙ₁ of the voltage signal input from the connecting line between the first sub-electrodes of the touch drive electrode after being attenuated is approximately equal to the minimum voltage value Vₘᵢₙ₂ of the voltage signal input from the end of the touch drive electrode after being attenuated. However, the maximum voltage value Vₘₐₓ₁ of the voltage signal input from the connecting line between the first sub-electrodes of the touch drive electrode is far greater than the maximum voltage value Vₘₐₓ₂ of the voltage signal input from the end of the touch drive electrode. Obviously, the uniformity of voltage signal input from the end of the touch drive electrode is smaller than that of the voltage signal input from the connecting line between the first sub-electrodes of the touch drive electrode.

In the touch display device of the above embodiment, patterns and materials of the touch drive electrode and the touch sensitive electrode are not limited. The substrate provided with the touch drive electrode may be the same as or different from the substrate provided with the touch sensitive electrode. When the same substrate is provided for both the touch drive electrode and the touch sensitive electrode, the touch drive electrode and the touch sensitive electrode may be disposed on a same layer or disposed on different layers spaced by an insulating layer.

The touch display device shown in FIGS. 1 and 2 are only used for illustrating that the signal transmission source and the detection circuit are connected with the touch drive electrode and the touch sensitive electrode by leads respectively, rather than for illustrating the relative positions of the signal transmission source and the detection circuit to the substrates. In practice, the signal transmission source and the detection circuit as well as the positions thereof on the substrates may be similar to those in the prior art and are not described herein.

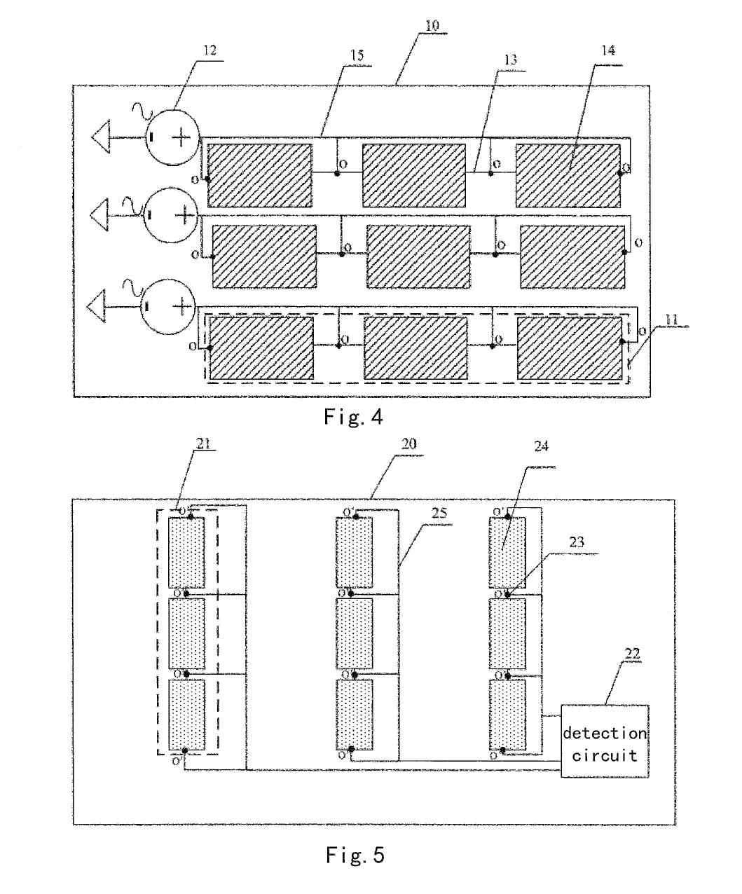

In order to further improve the uniformity of signal in the touch drive electrode and/or the touch sensitive electrode when a signal is transmitted therethrough, the signal transmission source 12 is also connected with at least one of two ends of the touch drive electrode 11 as shown in FIG. 4, and the detection circuit 22 is also connected with at least one of two ends of the touch sensitive electrode 21 as shown in FIG. 5. According to the embodiments of FIGS. 4 and 5, it is possible to avoid the problem that a voltage at an end of the touch drive electrode and/or the touch sensitive electrode is smaller, thereby further improving the uniformity of signal in the touch drive electrode and/or the touch sensitive electrode.

The ends of the touch drive electrode 11 refer to two terminals of the entire touch drive electrode extending in opposite directions, i.e., the end of the first or the last first sub-electrode which is not connected with any sub-electrode.

The ends of the touch sensitive electrode 21 refer to two terminals of the entire touch sensitive electrode extending in opposite directions, i.e., the end of the first or the last second sub-electrode which is not connected with any sub-electrode.

According to an exemplary embodiment, in the touch display device of the above embodiment, separations between the connecting points on the touch drive electrode (including the connecting lines) connected with the lead are equal to each other and/or separations between the connecting points on the touch sensitive electrode (including the connecting lines) connected with the lead are equal to each other.

That is to say, the connecting points on the touch drive electrode or the touch sensitive electrode connected with the respective lead are uniformly distributed. Thus, the uniformity of signal in the touch drive electrode and/or the touch sensitive electrode is higher and the touch effect is better.

According to an exemplary embodiment of the present invention, the lead for connecting the touch drive electrode and signal transmission source is made of metal or alloy. For example, the lead may be made of copper or aluminum, or an alloy containing at least one of copper and aluminum. The lead for connecting the detection circuit and the touch sensitive electrode is made of metal or alloy. For example, the lead may be made of copper or aluminum, or an alloy containing at least one of copper and aluminum. Due to a high conductivity, a good conductive property, a high signal transmission rate and a low signal attenuation of a metal or alloy, it is benefit to improve the touch effect of the touch display device.

According to an exemplary embodiment of the present invention, the connecting line for connecting the first sub-electrodes is made of metal or alloy. For example, the connecting line may be made of copper, aluminum, or an alloy containing at least one of copper and aluminum. The connecting line for connecting the second sub-electrodes is made of metal or alloy. For example, the connecting line may be made of copper, aluminum, or an alloy containing at least one of copper and aluminum. Due to a high conductivity, a good conductive property, a high signal transmission rate and a low signal attenuation of metal or alloy, it is benefit to improve the touch effect of the touch display device.

The touch display device as described above may be an Out Cell touch panel, an On Cell touch panel or an In Cell touch panel.

When the touch display device is an Out Cell touch panel, in a typical embodiment according to the present invention, the touch display device comprises the touch drive electrode and the touch sensitive electrode of the above embodiments of the present invention. Further, the touch drive electrode is disposed on the same layer as the touch sensitive electrode.

When the touch display device is an On Cell touch panel, the touch display device comprises the touch drive electrode and the touch sensitive electrode of the above embodiments of the present invention, and the touch drive electrode and the touch sensitive electrode are disposed on a side of a color filter substrate of the display panel away from the array substrate for performing a touch function.

When the touch display device is an In Cell touch panel, the touch display device comprises the touch drive electrode and the touch sensitive electrode of the above embodiments of the present invention, and the touch drive electrode and the touch sensitive electrode are disposed on a side of the color filter substrate close to the array substrate and/or on a side of the array substrate close to the color filter substrate. Alternatively, one of the touch drive electrode and the touch sensitive electrode is disposed on the color filter substrate, and the other is disposed on the array substrate.

A touch display device according to an exemplary embodiment of the present invention will be described below taking an In Cell touch panel in which the touch drive electrode and the touch sensitive electrode are disposed on a side of the array substrate close to the color filter substrate as an example.

The touch display device according to the embodiment of the present invention comprises an array substrate and a color filter substrate disposed oppositely, and a touch drive electrode and a touch sensitive electrode disposed on the array substrate. the structure of the color filter substrate and the array substrate are similar to those in the prior art expect that the touch drive electrode and the touch sensitive electrode are disposed according to the above embodiments of the present invention.

In order to improve an aperture ratio of pixels, the lead for connecting the signal transmission source with at least one first sub-source electrode or the connecting line between the first sub-electrodes is located in a non-display region between the pixels on the array substrate.

The lead for connecting the detection circuit with at least one second sub-source electrode or the connecting line between the second sub-electrodes is also located in a non-display region between the pixels on the array substrate.

The connecting line for connecting the first sub-electrodes in the touch drive electrode and the connecting line for connecting the second sub-electrodes in the touch sensitive electrode can be implemented in two implementations. In one implementation, the connecting line 13 for connecting the first sub-electrodes 14 as shown in FIG. 1 is a conductive sheet located between the first sub-electrodes 14, and/or the connecting line 23 for connecting the second sub-electrodes 24 as shown in FIG. 2 is a conductive sheet located between the second sub-electrodes 24.

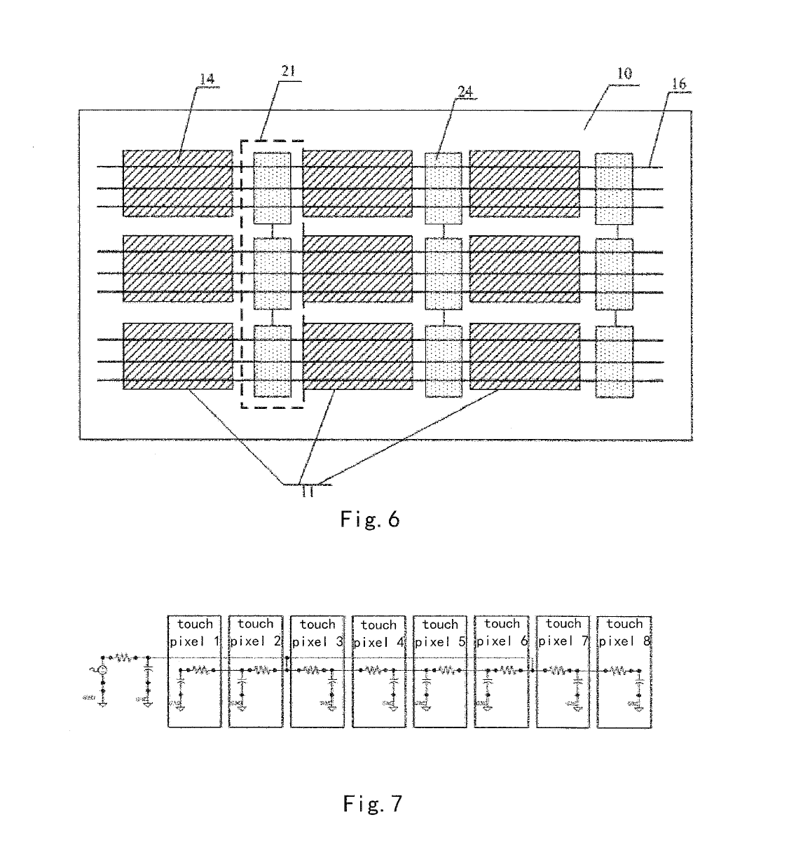

In the other implementation, referring to FIG. 6, the connecting line for connecting the first sub-electrodes 14 comprises one conductive wire or a plurality of conductive wires 16 parallel with one another for simultaneously connecting each first sub-electrode 14 of the touch drive electrode 11. The conductive wire 16 extends from the first sub-electrode 14 to the last first sub-electrode 14 and directly contact with each first sub-electrode 14 without an insulating layer therebetween.

Similarly, the connecting line for connecting the second sub-electrodes comprises one conductive wire or a plurality of conductive wires parallel with one another for simultaneously connecting each second sub-electrode of the touch sensitive electrode. The conductive wire extends from the first second sub-electrode to the last second sub-electrode and directly contact with each second sub-electrode without an insulating layer therebetween.

According to an exemplary embodiment of the present invention, each of the first sub-electrode and the second sub-electrode is of a rhombic or regular polygonal shape.

The touch display device in the above embodiments is one in which the touch drive electrode and the touch sensitive electrode are integrated in the display panel.

The display panel may be an organic light-emitting display panel, a liquid crystal display panel or the like.

When the display panel is a liquid crystal display panel, the liquid crystal display panel may use a vertical electric field mode or a transverse electric field mode. The liquid crystal display panel in the transverse electric field mode may be a liquid crystal display panel using an Advanced Super Dimension Switch (ADS) technology.

A description will be provided taken the liquid crystal display panel having ADS mode as an example. The array substrate and the color filter substrate may be any array substrate and color filter substrate suitable for the liquid crystal display panel having ADS mode.

Referring to FIG. 6, preferably, the touch drive electrode 11 is disposed on a same layer as the touch sensitive electrode 21. Further, referring to FIG. 6, the touch drive electrode 11 and the touch sensitive electrode 21 may serve as a common electrode (V_{com} electrode) 10. That is, the touch drive electrode 11 and the touch sensitive electrode 21 are time-divisionally driven, so that the touch drive electrode 11 and the touch sensitive electrode 21 will perform a function of the common electrode to drive the liquid crystals during an image display stage, and the touch drive electrode 11 and the touch sensitive electrode 21 will perform functions of touch drive and touch sensing during a touch stage.

To illustrate that disposing the touch drive electrode and the touch sensitive electrode according to the embodiment of the present invention can improve the uniformity of signal, taking the touch drive electrode as an example, the entire touch drive electrode are divided into 8 first sub-electrodes. Referring to FIG. 7 showing an equivalent simulation diagram of the touch drive electrode, each of the first sub-electrodes is a touch unit or a touch pixel). Different designs are simulated using Smart_Spice software in which different designs are simulated using the same signal transmission source, and resistances of peripheral wiring and corresponding parasitic capacitances are also the same.

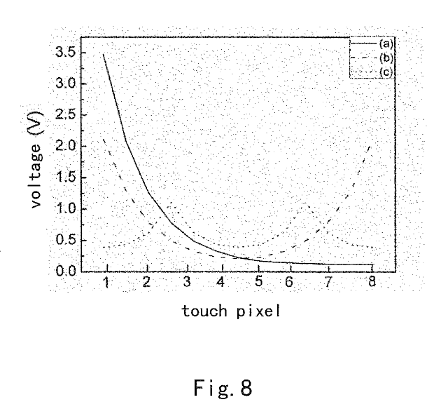

FIG. 8 is a schematic diagram showing comparison of a uniformity of signal between a touch drive electrode of the present invention with that of the prior art. In FIG. 8, the curve a represents a schematic graph of signal when a signal is input from one end of the touch drive electrode, the curve b represents a schematic graph of signal when a signal is input from both ends of the touch drive electrode, and the curve c represents a schematic graph of signal when a signal is input from the connecting line between the first sub-electrodes of the touch drive electrode. The simulation result represented by the curve b reflects the uniformity of signal in the touch drive electrode is about 10% which is triple than that represented by the curve a. This design, however, often employs bilateral peripheral wiring design and the uniformity of signal is substantially not adjustable for a certain display panel. The simulation result represented by the curve c reflects the uniformity of signal of the touch drive electrode is about 35%. Furthermore, it is possible to improve the uniformity of signal of the touch drive electrode by increasing the number of the leads connected to the touch drive electrode or the touch sensitive electrode, i.e., increasing the number of the connecting points at which the touch drive electrode or the touch sensitive electrode are connected with the leads.

In summary, embodiments of the present invention provide a touch display device in which the signal transmission source is electrically connected to the touch drive electrode at the connecting point between the first end and the second end of the touch drive electrode for transmitting a signal through the entire touch drive electrode; and/or the detection circuit is electrically connected to the touch sensitive electrode at the connecting point between the first end and the second end of the touch sensitive electrode for receiving a signal output from the touch sensitive electrode. The touch display device according to the present invention has high uniformity of signal and better touch effect as compared to that in which a signal is input from the end of the touch drive electrode.

Obviously, those skilled in the art may make various changes and modifications to the present invention without departing from the spirit and scope of the invention. The above embodiments may be used in any combinations without affecting the normal functions of the touch display device. Such changes and modifications will also fall within the spirit and scope of the present invention as defined in the appended claims and their equivalents.

What is claimed is:

1. A touch display device comprising:
a touch drive electrode extending in a first extension direction and including a first end and a second end opposite to the first end in the first extension direction of the touch drive electrode;
a touch sensitive electrode extending in a second extension direction and including a first end and a second end opposite to the first end in the second extension direction of the touch sensitive electrode;
a signal transmission source electrically connected to the touch drive electrode for providing the touch drive electrode with a voltage signal; and
a detection circuit electrically connected to the touch sensitive electrode for determining a position where a touch occurs on a touch panel of the touch display device,
wherein the signal transmission source is electrically connected to the touch drive electrode at a first connecting point located between the first end and the second end of the touch drive electrode; and/or
wherein the detection circuit is electrically connected to the touch sensitive electrode at a second connecting point located between the first end and the second end of the touch sensitive electrode.

2. The touch display device according to claim 1, wherein
the touch drive electrode comprises a plurality of first sub-electrodes connected with one another by first connecting lines;
the touch sensitive electrode comprises a plurality of second sub-electrodes connected with one another by second connecting lines;
the signal transmission source is connected, by a first lead, with at least one first sub-electrode located between the first end and the second end of the touch drive electrode or at least one first connecting line between the first sub-electrodes to transmit a signal to the entire touch drive electrode via the first lead; and/or
the detection circuit is connected, by a second lead, with at least one second sub-electrode located between the first end and the second end of the touch sensitive electrode or at least one second connecting line between the second sub-electrodes to receive a signal output from the second lead.

3. The touch display device according to claim 2, wherein
the signal transmission source is also connected with at least one of the first end and the second end of the touch drive electrode; and/or
the detection circuit is also connected with at least one of the first end and the second end of the touch sensitive electrode.

4. The touch display device according to claim 2, wherein
separations between the first connecting points on the touch drive electrode connected with the first lead are equal to each other; and/or
separations between the second connecting points on the touch sensitive electrode connected with the second lead are equal to each other.

5. The touch display device according to claim 4, wherein
the touch display device further comprises an array substrate on which the touch drive electrode and the touch sensitive electrode are disposed;
the first lead for connecting the signal transmission source with the touch drive electrode is located in a non-display region between pixels on the array substrate; and/or
the second lead for connecting the detection circuit with the touch sensitive electrode is located in the non-display region between the pixels on the array substrate.

6. The touch display device according to claim 5, wherein
the touch drive electrode and the touch sensitive electrode are time-divisionally driven, so that the touch drive electrode and the touch sensitive electrode serve as a common electrode performing a function of driving liquid crystals during an image display stage, and the touch drive electrode and the touch sensitive electrode perform a touch drive function and a touch sensing function respectively during a touch stage.

7. The touch display device according to claim 6, wherein
the first connecting line for connecting the first sub-electrodes is an electrically conductive sheet located between the first sub-electrodes; and/or
the second connecting line for connecting the second sub-electrodes is an electrically conductive sheet located between the second sub-electrodes.

8. The touch display device according to claim 6, wherein
the first connecting line for connecting the first sub-electrodes comprises one or more first conductive wires parallel with one another for simultaneously connecting each first sub-electrode of the touch drive electrode, the first conductive wire(s) directly contacting with each first sub-electrode without an insulating layer therebetween; and/or
the second connecting line for connecting the second sub-electrodes comprises one or more second conductive wires parallel with one another for simultaneously connecting each second sub-electrode of the touch sensitive electrode, the second conductive wire(s) directly contacting with each second sub-electrode without an insulating layer therebetween.

9. The touch display device according to claim 2, wherein
the first sub-electrode is of a rhombic or regular polygonal shape; and/or
the second sub-electrode is of a rhombic or regular polygonal shape.

10. The touch display device according to claim 2, wherein
Each of the first lead and the second lead is made of metal or alloy.

11. The touch display device according to claim 2, wherein
Each of the first connecting line and the second connecting line is made of metal or alloy.
